(19) United States
(12) Patent Application Publication
(10) Pub. No.: US 2025/0341364 A1
(43) Pub. Date: Nov. 6, 2025

(54) AUTOMATED DRYER

(71) Applicant: Maag Gala, Inc., Eagle Rock, VA (US)

(72) Inventor: Alisha KONST, Roanoke, VA (US)

(21) Appl. No.: 19/192,899

(22) Filed: Apr. 29, 2025

Related U.S. Application Data
(60) Provisional application No. 63/640,898, filed on May 1, 2024.

(51) Int. Cl. F26B 25/22; F26B 5/08; F26B 21/08; F26B 21/14

(52) U.S. Cl. CPC F26B 25/22; F26B 5/08; F26B 21/08; F26B 21/14; F26B 2200/08

(57) ABSTRACT

A centrifugal pellet dryer system includes a centrifugal dryer, a blower to generate counter-current airflow across the centrifugal dryer, damper(s), moisture sensor(s), airflow sensor(s), processor(s), and a memory. The processor(s) continuously monitor (i) the airflow across the centrifugal dryer via the airflow sensor(s), (ii) the moisture level of the pellets via the moisture sensor(s), (iii) a blower motor load, and (iv) a centrifugal dryer motor load. The processor(s) determine whether the airflow falls below a predetermined threshold, and responsive to such determination, automatically initiate a water and/or air spray to reduce fines within the centrifugal dryer. The processor(s) continuously compare the moisture level of the pellets to predetermined threshold(s), and dynamically adjust the damper(s) and/or the blower motor load, thereby adjusting the moisture level of the pellets. The processor(s) continuously determine whether the slurry requires additional or less water, and automatically adjust water to the slurry based on such determination.

### CROSS-REFERENCE TO RELATED APPLICATIONS

This application claims priority under 35 U.S.C. § 119 to U.S. Provisional Patent Application No. 63/640,898, filed May 1, 2024, entitled “AUTOMATED CENTRIFUGAL PELLET DRYER (PLASTICS PROCESSING MACHINE) WITH INDEPENDENT CONTROL OF COUNTER-CURRENT AIRFLOW, SLURRY COMPOSITION, AND TIMING OF SELF-CLEANING FUNCTIONS,” the entire contents of which are fully incorporated herein by reference.

### FIELD

The present invention generally relates to plastics processing and material handling, and specifically to an automated centrifugal pellet dryer with independent control of counter-current airflow, slurry composition adjustment, and self-cleaning functions.

### BACKGROUND

Plastics processing machines, such as centrifugal pellet dryers, are used in the plastics industries for drying plastic pellets efficiently. Incorporating counter-current airflow throughout the dryer housing can help increase dryer efficiency, contain hot/humid air from downstream equipment, provide uniform drying, and reduce energy consumption.

Accordingly, there is a need for an improved automated centrifugal pellet dryer. Embodiments of the present disclosure are directed to these and other considerations.

### SUMMARY

In accordance with certain embodiments of the present disclosure, a centrifugal pellet dryer system is disclosed. The centrifugal pellet dryer system can include a centrifugal dryer having a slurry inlet, a first pellet outlet, an air inlet, an air outlet, a housing, and a rotor. The rotor is disposed within the housing and includes one or more lifters and one or more spray nozzles, the rotor configured to convey pellets, via the one or more lifters, upwardly through the centrifugal dryer and discharge the pellets from the first pellet outlet. The centrifugal pellet dryer system can include a blower connected to the air outlet of the centrifugal dryer, the blower configured to generate counter-current airflow in relation to a flow of the pellets across the centrifugal dryer. The centrifugal pellet dryer system can include one or more dampers positioned at the air outlet. The centrifugal pellet dryer system can include one or more moisture sensors configured to monitor a moisture level of the pellets. The centrifugal pellet dryer system can include one or more airflow sensors configured to monitor an airflow across the centrifugal dryer. The centrifugal pellet dryer system can include one or more processors, and a memory in communication with the one or more processors and storing instructions that, when executed by the one or more processors, are configured to cause the one or more processors to perform a method of plastics processing. The method can include continuously performing a series of steps until a predetermined amount of dried pellets have been produced. The steps can include monitoring (i) the airflow across the centrifugal dryer via the one or more airflow sensors, (ii) the moisture level of the pellets via the one or more moisture sensors, (iii) a first motor load of the blower, and (iv) a second motor load of the centrifugal dryer. The steps can include determining whether the airflow falls below a first predetermined threshold. Responsive to determining the airflow falls below the first predetermined threshold, the steps can include automatically initiating a spray via the one or more spray nozzles thereby reducing a build-up of fines within the centrifugal dryer, the spray comprising water, air, or both. The steps can include comparing the moisture level of the pellets to one or more second predetermined thresholds. Responsive to comparing the moisture level to the one or more second predetermined thresholds, the steps can include dynamically adjusting the one or more dampers, the first motor load of the blower, or both, thereby adjusting the moisture level of the pellets. The steps can include determining whether the slurry requires additional or less water based on the second motor load of the centrifugal dryer. Responsive to determining the slurry requires additional or less water, the steps can include automatically adjusting an amount of water to the slurry.

In accordance with certain embodiments of the present disclosure, a centrifugal pellet dryer system is disclosed. The centrifugal pellet dryer system can include a centrifugal dryer comprising having a slurry inlet, a first pellet outlet, an air inlet, and an air outlet. The centrifugal pellet dryer system can include a blower connected to the air outlet of the centrifugal dryer, the blower configured to generate counter-current airflow in relation to a flow of pellets across the centrifugal dryer. The centrifugal pellet dryer system can include one or more dampers positioned at the air outlet. The centrifugal pellet dryer system can include one or more moisture sensors configured to monitor a moisture level of the pellets. The centrifugal pellet dryer system can include one or more processors, and a memory in communication with the one or more processors and storing instructions that, when executed by the one or more processors, are configured to cause the one or more processors to perform a method of plastics processing. The method can include continuously monitoring (i) the moisture level of the pellets via the one or more moisture sensors, (ii) a first motor load of the blower, and (iii) a second motor load of the centrifugal dryer. The method can include continuously comparing the moisture level of the pellets to one or more second predetermined thresholds. Responsive to continuously comparing the moisture level to the one or more second predetermined thresholds, the method can include dynamically adjusting the one or more dampers, the first motor load of the blower, or both, thereby adjusting the moisture level of the pellets. The method can include continuously determining whether the slurry requires additional or less water based on the second motor load of the centrifugal dryer. Responsive to determining the slurry requires additional or less water, the method can include automatically adjusting an amount of water to the slurry.

In accordance with certain embodiments of the present disclosure, a method of processing plastics through a centrifugal dryer is disclosed. The method can include directing a slurry through the centrifugal dryer, the slurry comprising pellets and water. The method can include continuously monitoring (i) an airflow across the centrifugal dryer via one or more airflow sensors, (ii) a moisture level of the pellets in the centrifugal dryer via one or more moisture sensors, and (iii) a first motor load of the centrifugal dryer. The method can include determining whether the airflow falls below a first predetermined threshold. Responsive to determining the airflow falls below the first predetermined threshold, the method can include automatically initiating a self-cleaning function thereby reducing a build-up of fines within the centrifugal dryer. The method can include continuously comparing the moisture level of the pellets to one or more second predetermined thresholds. Responsive to continuously comparing the moisture level to the one or more second predetermined thresholds, the method can include dynamically adjusting one or more components of a blower connected to the centrifugal dryer, thereby adjusting the moisture level of the pellets. The method can include continuously determining whether the slurry requires additional or less water based on the first motor load of the centrifugal dryer. Responsive to determining the slurry requires additional or less water, the method can include automatically adjusting an amount of water to the slurry.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is an exemplary centrifugal pellet dryer, in accordance with certain embodiments of the present disclosure.

FIG. 2 is an exemplary system for processing plastics, in accordance with certain embodiments of the present disclosure.

FIG. 3 is an exemplary system for processing plastics, in accordance with certain embodiments of the present disclosure.

FIG. 4 is an exemplary dewatering device, in accordance with certain embodiments of the present disclosure.

FIG. 5 is a perspective view of an exemplary dryer assembly rotor, in accordance with certain embodiments of the present disclosure.

FIG. 6 is a schematic of an exemplary system for processing plastics, in accordance with certain embodiments of the present disclosure.

FIG. 7 is a schematic of an exemplary control unit for processing plastics, in accordance with certain embodiments of the present disclosure.

FIG. 8 is a flowchart of an exemplary method for processing plastics, in accordance with certain embodiments of the present disclosure.

FIG. 9 illustrates components of an exemplary centrifugal pellet dryer, in accordance with certain embodiments of the present disclosure.

FIGS. 10A and 10B illustrate components of a exemplary centrifugal pellet dryer, in accordance with certain embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

Existing centrifugal pellet dryer systems often rely on manual adjustments or fixed settings for airflow control, leading to energy waste and inefficiencies in drying conditions. The present disclosure thus provides a centrifugal pellet dryer system with automated control of counter-current airflow, slurry composition, and timing of self-cleaning function. The disclosed system can include a centrifugal dryer with integral self-cleaning functions, a tempered water system for pellet production, a blower providing counter-current airflow, an air filtration device, dampers, airflow and moisture sensors, and a control unit. The blower generates negative pressure airflow within the dryer housing to facilitate the drying process of pellets. The automated counter-current airflow control adjusts the dampers or motor speed based on sensed airflow volume to optimize drying efficiency and reduce energy consumption. When the system senses that the dryer airflow impedance has reached a critical level from the build-up of fines, it triggers a self-cleaning cycle. Pellets can be temporarily diverted out of the production stream as a water spray nozzle is processed across the outer surface of the dryer screens and/or water spray nozzles on the dryer rotor and/or dryer screens are activated. The automated slurry composition control adjusts the tempered water system pump speed and/or injects water directly to the dryer feed based on dryer motor load to keep a consistent rate of pellets going through the dryer.

The disclosed centrifugal pellet dryer systems, with several automated features, offer significant advantages over existing drying systems. By dynamically and independently adjusting airflow, adjusting slurry composition, and initiating self-cleaning cycles based on sensed parameters, the systems optimize drying efficiency, reduce energy consumption, and enhance product quality. The disclosed systems can also be used in a variety of industries and applications requiring efficient pellet drying processes.

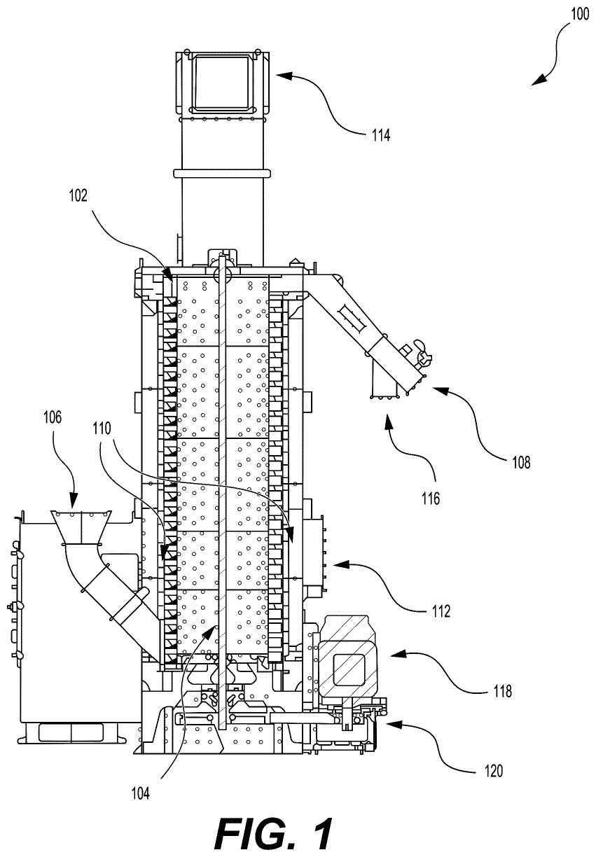

Reference will now be made in detail to exemplary embodiments of the disclosed technology, examples of which are illustrated in FIGS. 1-8, and disclosed herein. Wherever convenient, the same reference numbers will be used throughout the drawings to refer to the same or like parts.

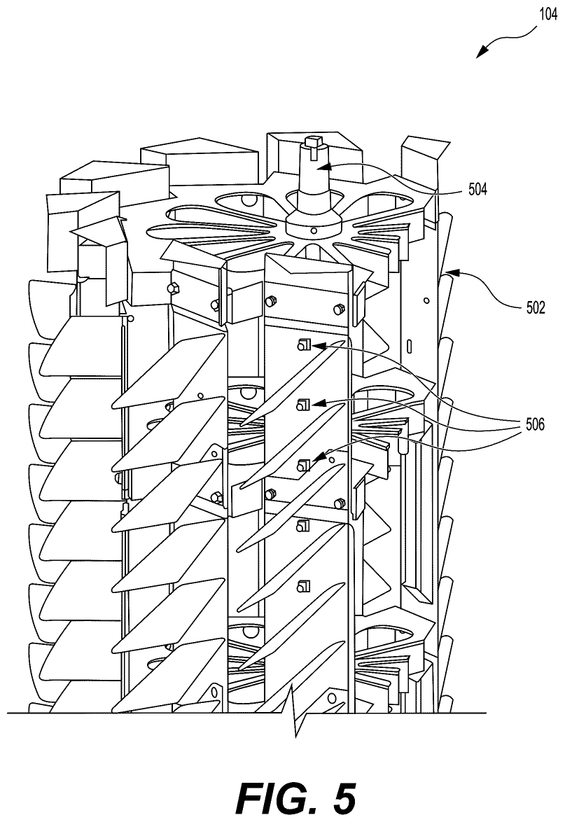

FIG. 1 is an example centrifugal pellet dryer 100 that can be incorporated into the centrifugal pellet dryer systems disclosed herein. The dryer 100 can include a dryer housing 102 equipped with a rotor 104 for lifting a slurry of pellets, e.g., via one or more lifters or lifting assemblies 502 (FIG. 5), and water from a dryer slurry inlet 106 near the bottom of the dryer 100, to a dry pellet outlet 108 near the top of the dryer housing 102. As the pellets are lifted and thrown against one or more screens 110 within the housing 102 and surrounding the rotor 104, the water is separated from the pellets and is returned to the water system through a drain in the bottom of the housing 102. In this process, small features on the pellet surface that are artifacts of cutting the pellet, are knocked off. These are known as fines and accumulate inside the dryer housing 102 impeding airflow. As the water is propelled outward from the screens 110 by the rotating rotor 104, residual moisture and humidity are removed by way of a counter-current airflow passing through and around the pellets and flowing opposite to the direction of flow of the pellets, as further discussed below. Having too much airflow can impede the flow of pellets out of the pellet outlet 108, while having too little airflow can leave the pellets with higher than desired moisture content. As such, a blower 202, further discussed below, for providing a volume of airflow is connected to the dryer's air outlet 112 to generate negative pressure airflow counter to the flow of pellets within the housing 102. The pellets to be dried are introduced via a water slurry into the dryer housing through the slurry inlet 106 at the bottom, and the dried pellets are discharged through the pellet outlet 108 at the top. The counter-current airflow is introduced through the pellet outlet 108 and/or a secondary inlet 114 at the dryer top. The moisture-laden air is then pulled through the air outlet 112 in the side of the dryer housing 102.

As further discussed below, the centrifugal dryer 100 can further include a secondary outlet 116 for diverting any out-of-spec pellets, a dryer motor 118, and drive components 120.

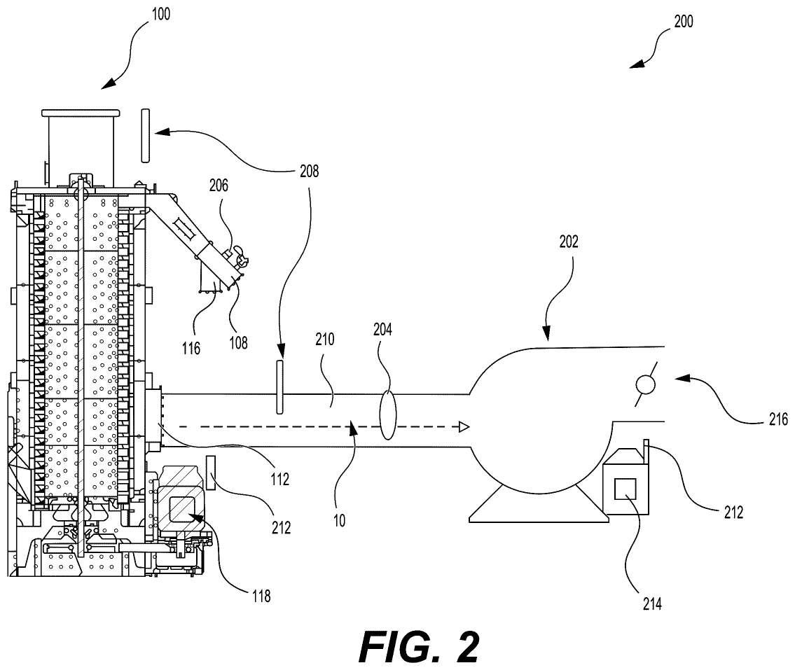

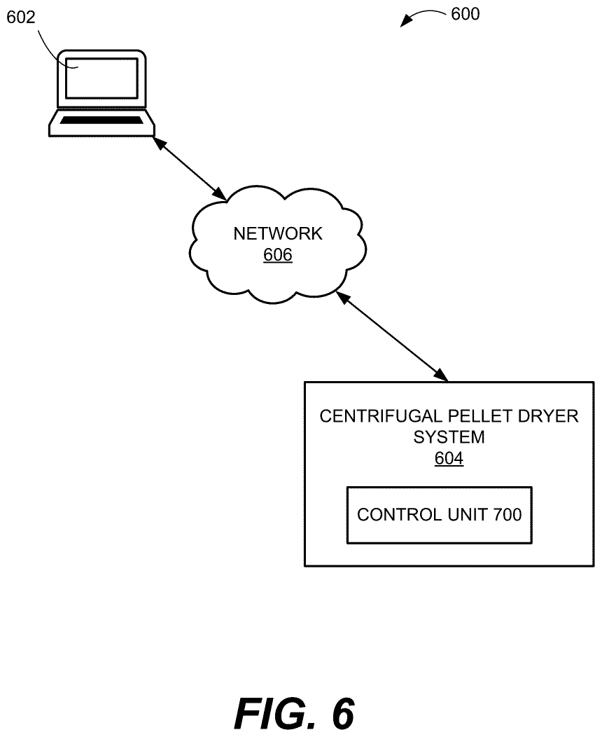

FIG. 2 is an example system 200 for use in plastics processing. The system includes centrifugal dryer 100, and a blower 202 connected to the air outlet 112 of the dryer 100 and configured to generate counter-current airflow across the dryer 100. The system 200 can include one or more dampers 204, one or more moisture sensors 206 configured to monitor a moisture level of the pellets, one or more airflow sensors 208 (e.g., pressure sensors), and a control unit 700 (FIG. 6).

The damper(s) 204 can be positioned in the air outlet ductwork 210 of the centrifugal dryer 100 and/or at the blower 202. These dampers are adjustable to regulate the overall airflow 10 and the ratio of airflow rate entering the blower relative to the airflow rate exiting the dryer.

The moisture sensor(s) 206 can be positioned at the pellet outlet 108 to monitor pellet moisture.

The system 200 may include one or more additional sensors 212 to monitor, for example, current or load of the blower motor 214 and/or the dryer motor 118.

The airflow sensor(s) 208 can be used to determine the airflow rate through the centrifugal dryer 100, and can be placed within the dryer air outlet ductwork 210 and in ambient conditions near the dryer air inlet to measure the airflow rate. The airflow sensor(s) 208 can be composed of one or more static pressure sensing elements in the air outlet ductwork 210 of the centrifugal dryer 100 upstream of the blower 202 and in ambient conditions at the centrifugal dryer 100. While existing systems use a static pressure sensor at the air inlet, which adds noise to the signal making it undesirable for use in process control, the systems disclosed herein place the static pressure sensor outside the dryer in ambient conditions, providing a more useable signal. The signals from the airflow sensor(s) 208 can be routed to the control unit 700, which can be, for example, a microcontroller or a programmable logic controller (PLC) configured to continuously compute airflow from the pressure sensors 208 based on machine-specific formulas and/or the pressure data from the sensors 208. The computed airflow rate can be displayed (e.g., via a display of user device 602, FIG. 6) and used as a control signal for the blower 202 variable frequency drive or an adjustable orifice 216 at the blower outlet to maintain the desired airflow through the dryer 100.

In operation, the control unit 700 continuously monitors airflow parameters and adjusts the applied blower 202 suction force in real time to compensate for various factors that change the dryer air impedance, including but not limited to: build-up of fines within the dryer, changes in product rates or product types, and changes in process water rates. By integrating the signal of motor load, the controller can monitor for surging output, seen as surges in the motor current, and reduce the airflow to correct for this. By integrating signals from upstream equipment producing the pellets, the system is able to adjust for the changes in product rate, not only regulating airflow to compensate for the changing impedance, but also increasing or decreasing airflow based on product rate to achieve efficient drying. By dynamically adjusting the dampers and/or blower motor speed based on sensed airflow volume, the system reduces energy consumption and improves overall drying conditions and efficiency.

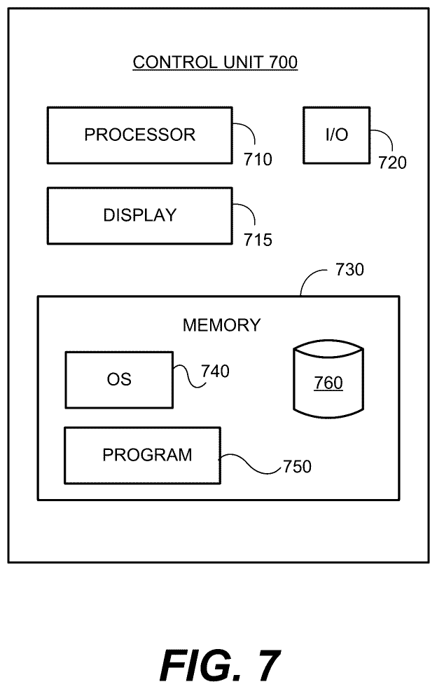

In some embodiments, the system may be configured to continuously display various parameters of the system, such as the airflow rate, moisture level, blower motor load, dryer motor load, etc. The system may conduct such display via user device 602 (FIG. 6) and/or display 715 of control unit 700 (FIG. 7).

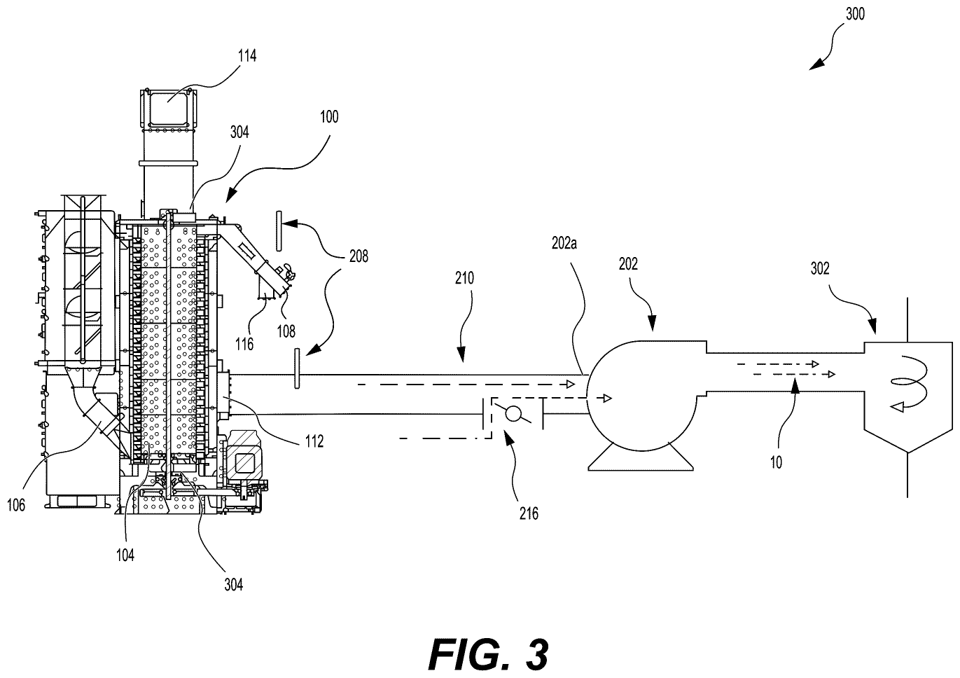

FIG. 3 is another example system 300 for use in plastics processing. As shown, system 300 can include one or more of the same components as system 200, discussed above. For example, system 300 can include the centrifugal dryer 100, blower 202, and airflow sensor(s) 208. System 300 can also include control unit 700; however, the output of the control loop for airflow is configured via the adjustable port 216, that is now positioned in the air outlet ductwork 210 between the outlet 112 of the dryer 100 and the inlet 202a of the blower 202, in addition to the blower speed and/or output damper.

System 300 can further include an air filtration device 302 positioned downstream of the blower (e.g., the blower outlet), such as but not limited to a cyclone. Air filtration device 302 requires significantly more airflow than the dryer 100 that in this case shares the same blower 202 for reduced energy consumption. The blower pulls air from the dryer 100 and the adjustable intermediate port 216 combined, then pushes into the cyclone 302. The blower is controlled to provide the higher airflow rate required for the cyclone. The adjustable intermediate port 216 can be automatically adjusted (e.g., opened or closed) to adjust the airflow through the dryer 100, and controlled based on calculated airflow through the dryer to keep the dryer's airflow at a required level while still supplying the required airflow to the cyclone.

In some embodiments, the systems disclosed herein (e.g., system 200, 300, 600) can be used to control airflow to the dryer 100 by relying on real time moisture measurements from the dryer pellet outlet 108. The employed system can use a resistive and/or capacitive type moisture sensor 208 at the pellet outlet 108 to monitor pellet moisture and increase airflow as required to keep pellets within a user-selectable moisture range. The moisture sensor(s) 208 can have metal contact plates positioned in an area around or adjacent to the pellet outlet 108 that gets constantly hit with pellets during operation, ensuring both a large sample in a short time for accuracy, and that the pellet strikes keep the contact plates clear of fines which could generate false readings. If the pellet moisture sensor indicates the pellets are wetter than the selected range, the system can dynamically increase airflow rate to the dryer to further dry the pellets. If the pellet moisture sensor indicates the pellets are dryer than the selected range, the system can dynamically decrease the airflow through the dryer to reduce energy consumption. If the system is not able to maintain the selected moisture range, it can provide an alert or notification, for example, via user device 602, and/or divert the out-of-spec pellets to a secondary outlet 116 for quarantine or additional processing, thus avoiding contaminating large batches of product.

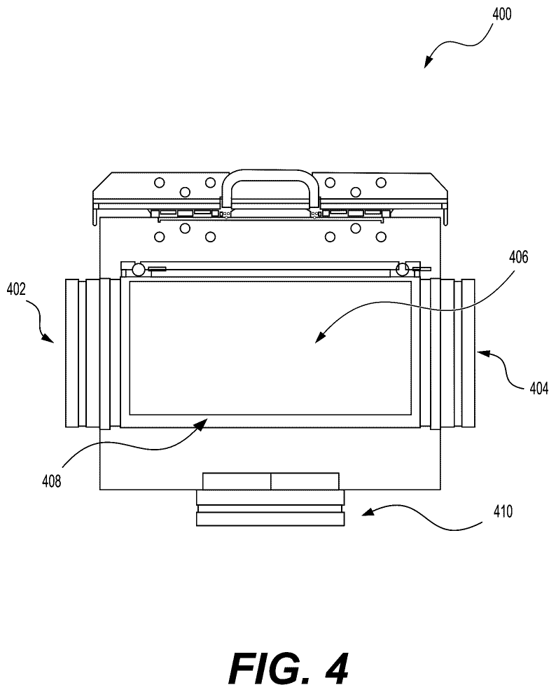

In some embodiments, the systems disclosed herein (e.g., system 200, 300, 600) can be used to measure dryer motor load and bearing vibration patterns and adjust incoming slurry composition to maintain constant product rate through the dryer. The employed system uses one or more dryer motor current sensors 212 (FIG. 2), and one or more bearing vibration sensors 304 (e.g., at the top and bottom of the rotor 104) to monitor and correct for irregularities in the composition of the incoming slurry. The dryer 100 operates most efficiently with a consistent product and water rate. Equipment used upstream of the system for producing the pellets, pumping the slurry water, and filtering out agglomerates can occasionally produce cyclical patterns of above and below nominal pellet rates, commonly referred to as surge feeding. Surge feeding, in addition to creating variance in the moisture content of the output pellets, can cause damage to the motor 118, drive components 120, rotor 104 and screens 110. When the system detects a cyclical pattern in the motor load sensor(s) 212 and/or bearing vibration sensor(s) 304, it can act to cyclically add more water to the slurry in time with the increasing motor loads and bearing vibrations. By adding water to the slurry, the system changes the slurry composition and reduces the rate that pellets can enter the dryer. The system can add water to the slurry via several methods depending on the particular application. It can change the speed of a water pump that feeds the slurry, inject additional water into the slurry as it enters the dryer, and/or modulate dewatering devices, such as the example device 400 shown in FIG. 4, in the incoming slurry line upstream of the dryer 100. In some embodiments, based on the monitoring of the motor load sensor(s) 212 and/or bearing vibration sensor(s) 304, the system can reduce the amount of water being added to the slurry, for example, by dialing back the speed of the water pump and/or modulating dewatering devices.

FIG. 4 provides an example upstream dewatering device 400. When such device 400 is used, the system (e.g., system 200, 300) modulates slurry composition with the upstream dewatering device such as the Horizontal Pre-Dewatering device (HPD) shown in FIG. 4. Slurry enters the dewatering device 400 at the slurry inlet 402 and exits at the slurry outlet 404. While inside the HPD, the slurry flows across a motorized rotatable round screen 406 with a length-wise section blanked-off 408. When the screen is rotated such that the blanked-off section is at the top, the slurry flows across the screen and some of the water falls through, exiting the HPD at the water outlet 410. When the screen is rotated such that the blanked-off section is on the bottom as shown, less water is able to fall through the screen and exit the slurry flow. By controlling the motor that rotates the round screen 406 and partial blanked-off screen 408, the system is able to control how much water is removed from the slurry flow to keep the composition consistent, and thus the dryer 100 at efficient performance. In some embodiments, the slurry is surrounded by a perforated section of the device 400 such that water can be removed in a horizontal and/or vertical direction. When removing water in a vertical direction, internal baffles of the device can be actuated to have a more acute angle thereby forcing more water out of the screens.

In some embodiments, the systems disclosed herein (e.g., system 200, 300) can be used to automatically conduct one or more functions, such as initiating a dryer self-cleaning function and/or providing an alert or notification that the dryer requires cleaning (e.g., generating an alert and/or transmitting an alert to a user device). By comparing the airflow rate through the dryer 100 to the blower 202 speed and/or damper settings, the system can determine when the dryer 100 will become so clogged with fines that the blower will no longer be able to deliver the required airflow and/or that the resulting airflow path within the dryer impedes the flow for pellets out of the dryer. At such time, the system automatically initiates a self-cleaning cycle within the dryer 100 and/or provides an alert indicating the dryer requires cleaning. The alert can be in a variety of forms, such as a sound, an alarm, a notification via, e.g., user device 602 or some other component of the dryer or centrifugal pellet dryer system (e.g., display 715 of control unit 700). The self-cleaning cycle employs a pressurized water and/or air spray to dislodge the fines that have accumulated inside the dryer 100. The majority of the fines that effect the dryer airflow impedance, and thus overall drying performance, accumulate on the outside of the screens 110. Because additional water and/or air is sprayed inside the dryer for the cleaning, the dryer is not able to output dry pellets like normal during the self-cleaning cycle. For this reason, the system can automatically and temporarily divert the pellets to the secondary outlet 116 to keep the pellets from contaminating a production batch. The diverted pellets can be subjected to additional processing (e.g., dried) and returned to production, or can be discarded.

In some embodiments, as particularly shown in FIG. 5, the rotor 104 used in conjunction with the self-cleaning function can be a Clean Cycle rotor. This rotor 104 has a hollow shaft 502 into which pressurized water or air is fed during the self-cleaning operation. The rotor maintains its nominal rotation speed during the self-cleaning cycle to evenly distribute the spray around the screens 110. The pressurized water or air is plumbed from the hollow shaft to outward facing spray nozzles 506 located on the lifter assemblies 502. Spray from these nozzles passes through the screens and dislodges the fines accumulated on the outside. The fines are then swept up in the water flowing out of the dryer and carried to the tempered water system tank where they are filtered out of the water. In some embodiments, the spray nozzles 506 can be located on an outer surface of the screens 110.

In some embodiments, the self-cleaning function can incorporate a water and/or air blade that is swept down the outer surface of the screens 110. The water and/or air blade is a long thin nozzle shaped to match the curvature of the screens that creates a high pressure sheet of water or air. The water/air blade nozzle is oriented downward, and held close to the outer surface of the screens. As the blade is swept down the outer surface of the screen, it dislodges the accumulated fines. The fines are then swept up in the water flowing out of the dryer and carried to the tempered water system tank where they are filtered out of the water.

FIG. 6 shows an example system 600 used for processing plastics. System 600 can incorporate any of the centrifugal pellet dryer systems disclosed herein. For example, centrifugal pellet dryer system 604 may be the same as or similar to centrifugal pallet dryer system 200 or 300, discussed above. As discussed herein, the centrifugal pellet dryer system 604 can include a control unit 700, more specifically shown in FIG. 7. System 600 can further include a user device 602 (e.g., a laptop computer, smartphone, smart tablet, etc.) that can be used for receiving, displaying, or computing data collected, monitored, and/or generated by the centrifugal pellet dryer system 604. The user device 602 and centrifugal pallet dryer system 604 can communicate via network 606 that may be any type of wired or wireless network.

FIG. 7 shows a schematic of the control unit 700. As shown, control unit 700 can include one or more processors 710, a display 715, an input/output (I/O) device 720, and a memory 730 that itself can include an operating system (OS) 740, one or more programs 750, and a database 760. It should be understood that control unit 700 can be configured to include a variety of components such that the control unit 700 can receive, monitor, compute, and/or generate data based on parameters (e.g., airflow, moisture, motor load, etc.) of the different components of the centrifugal pallet dryer system, as discussed herein. As discussed above, control unit 700 can be a microcontroller or a PLC.

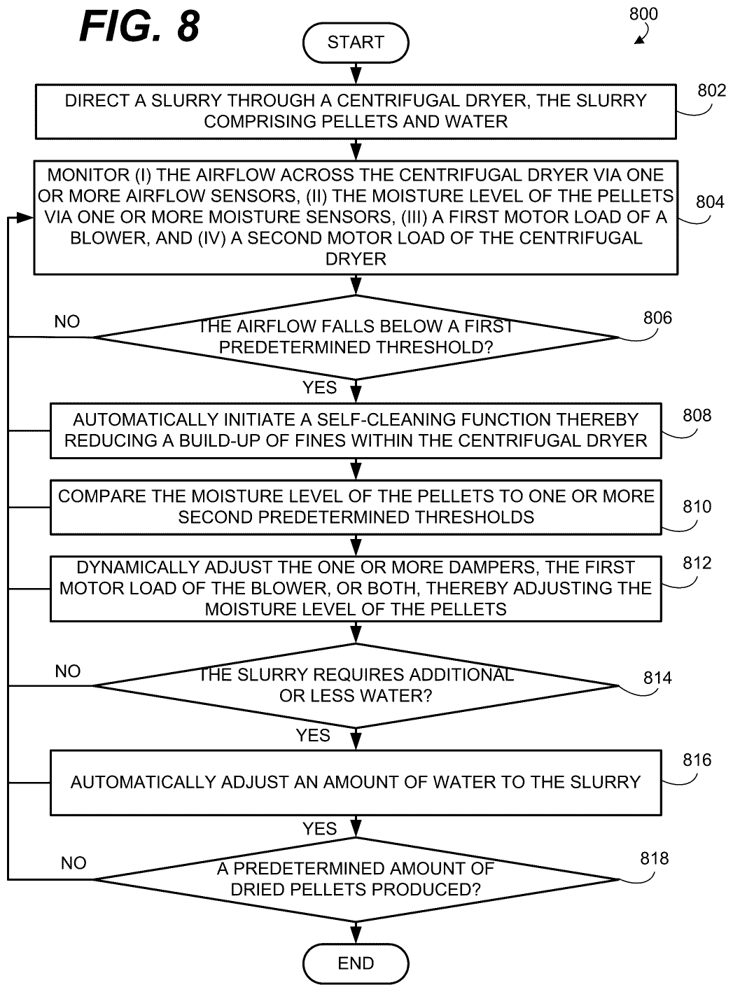

FIG. 8 is a flowchart of an example method 800 for processing plastics. Method 800 may be conducted using any of the systems disclosed herein. It should be understood that one or more of the following blocks may be optional.

In block 802, the method can include directing a slurry through a centrifugal dryer, the slurry comprising pellets and water. For example, as discussed herein, a slurry may be directed (e.g., pumped) into a centrifugal dryer (e.g., dryer 100) through a slurry inlet 106.

In block 804, the method can include continuously monitoring (i) the airflow across the centrifugal dryer via one or more airflow sensors (e.g., sensors 208), (ii) the moisture level of the pellets via one or more moisture sensors (e.g., sensors 206), (iii) a first motor load of the blower (e.g., blower 202), and (iv) a second motor load of the centrifugal dryer. As discussed herein, the system may be configured to continuously monitor one or more of these parameters to provide dynamic and automatic functions to improve dryer efficiency.

In block 806, the method can include determining whether the airflow falls below a first predetermined threshold. For example, the system may determine whether the airflow falls below a specific impedance threshold such that it can determine the system (e.g., dryer 100) is plugged with fines.

In block 808, responsive to determining the airflow does not fall below the first predetermined threshold, the method can include continuously monitoring the parameter(s) of block 804. Alternatively, responsive to determining the airflow falls below the first predetermined threshold, the method can include automatically initiating a self-cleaning function to reduce a build-up of fines within the dryer. The self-cleaning function can include any of the self-cleaning functions described herein.

In some embodiments, responsive to determining the airflow falls below the first predetermined threshold, the system can automatically divert the pellets, for example, out of the secondary pellet outlet 116, before automatically initiating the self-cleaning function.

In block 810, the method can include comparing the moisture level of the pellets to one or more second predetermined thresholds, for example, to determine if the pellets are too wet or too dry based on product specifications.

In block 812, the method can include dynamically adjusting the damper(s) (e.g., damper(s) 204) and/or the blower motor load to adjust the moisture level of the pellets. For example, as discussed herein, if the pellets are too dry (e.g., satisfy a first threshold), the system can dynamically adjust damper(s) and/or blower motor load to decrease airflow to the dryer, while conversely if the pellets are too wet (e.g., satisfy a second threshold), the system can provide such dynamic adjustment to increase airflow to the dryer.

In some embodiments, if the system determines the pellets satisfy a certain threshold (e.g., the system cannot determine a moisture level of the pellets), the system can automatically divert the pellets, for example, out of the secondary pellet outlet 116.

In block 814, the method can include determining whether the slurry requires additional or less water. As disclosed herein, the system may be configured to determine whether any slurry composition adjustment is needed to keep a consistent rate of pellets going through the dryer to aid in dryer efficiency and performance.

In some embodiments, the system may continuously monitor one or more rotor bearing vibration sensors (e.g., sensors 304) configured to monitor one or more vibration patterns of the rotor. Determining whether the slurry requires more or less water may be further based on the monitored rotor vibration patterns. For example, increased vibration may be a sign of the pellets becoming too dry and/or clogging inside the dryer 100, and hence, the system may determine additional water is required. As another example, increased vibration may be a sign that the slurry composition, a mixture of pellets and process water, has become too pellet heavy to effectively convey the pellets, and thus additional water may be required. As another example, increased vibration and/or a change in motor load may be a sign that the slurry composition includes too much water.

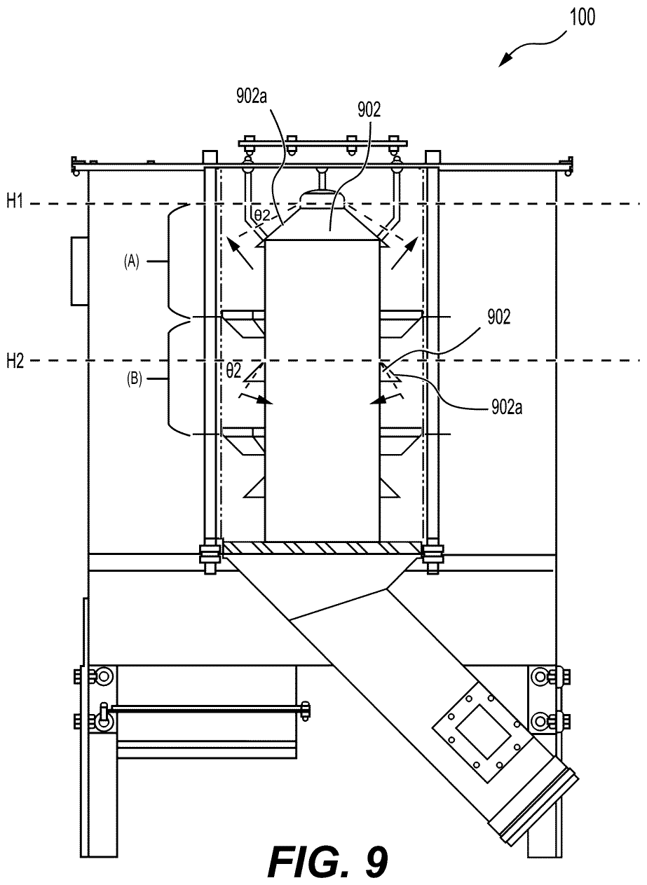

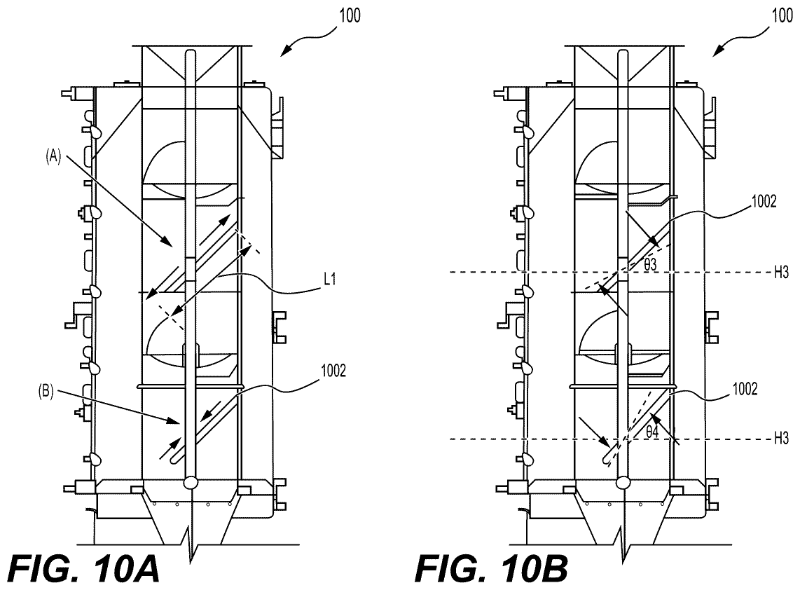

In block 816, responsive to determining the slurry requires more or less water, the method can include automatically adjusting an amount of water to the slurry. As discussed herein, adjusting the amount of water added to the slurry may be conducted by adjusting the amount of water directly added into the slurry feed to the dryer, dynamically adjusting a pump speed of a water pump (e.g., a tempered water pump) located upstream of the dryer, adjusting perforation in the dryer screens, changing the number of blank screens in use, and/or by adjusting the angle of one or more internal components of the dryer. For example, as shown in FIG. 9, the dryer 100 may include one or more first internal components 902 (e.g., baffles) having one or more sloped outer surfaces 902a. As shown, the angle of one or more outer surfaces 902a of the first internal component(s) 902 may be adjusted to remove more or less water from the slurry within the dryer. As shown in section (A) of the dryer, the outer surfaces 902a can be adjusted upward to decrease an angle θ1 of the outer surface 902a in relation to a horizontal plane HI to thereby remove more water from the slurry in the dryer. As shown in section (B) of the dryer, the outer surfaces 902a can be adjusted downward to increase an angle θ2 of the outer surface 902a in relation to a horizontal plane H2 to thereby remove less water from the slurry. As another example, as shown in FIGS. 10A and 10B, the dryer 100 may include one or more second internal components 1002 (e.g., baffles). As shown in FIG. 10A, a length L1 of the second internal components 1002 may be increased (A) thereby removing more water from the slurry, or decreased (B) thereby removing less water from the slurry. As shown in FIG. 10B, an angle of the second internal components 1002 in relation to a horizontal plane H3 can be adjusted to either decrease the angle θ3 thereby removing more water from the slurry, or increase the angle θ4 thereby removing less water from the slurry.

In block 818, the method can include determining whether a predetermined amount of dried pellets (e.g., in-spec pellets) have been produced (e.g., outputted from the dryer 100), for example, based on the demands of a specific application. As the systems and methods disclosed herein can be performed on a continuous basis, the method may include determining (e.g., periodically or at some predefined time interval) whether some predetermined amount of dried pellets have been produced from the system, and if so, one or more components or steps of the system or method may stop.

In some examples, disclosed systems or methods may involve one or more of the following clauses:

Clause 1: A centrifugal pellet dryer system comprising: a centrifugal dryer comprising: a slurry inlet; a first pellet outlet; an air inlet(s); an air outlet(s); a housing; and a rotor disposed within the housing and comprising one or more lifters and one or more spray nozzles, the rotor configured to convey pellets, via the one or more lifters, upwardly through the centrifugal dryer and discharge the pellets from the first pellet outlet; a blower connected to the air outlet of the centrifugal dryer, the blower configured to generate counter-current airflow in relation to a flow of the pellets across the centrifugal dryer; one or more dampers positioned at the air outlet; one or more moisture sensors configured to monitor a moisture level of the pellets; one or more airflow sensors configured to monitor an airflow across the centrifugal dryer; one or more processors; and a memory in communication with the one or more processors and storing instructions that, when executed by the one or more processors, are configured to cause the one or more processors to: continuously, until a predetermined amount of dried pellets have been produced: monitor (i) the airflow across the centrifugal dryer via the one or more airflow sensors, (ii) the moisture level of the pellets via the one or more moisture sensors, (iii) a first motor load of the blower, and (iv) a second motor load of the centrifugal dryer; determine whether the airflow falls below a first predetermined threshold; responsive to determining the airflow falls below the first predetermined threshold, automatically initiate a spray via the one or more spray nozzles thereby reducing a build-up of fines within the centrifugal dryer, the spray comprising water, air, or both; compare the moisture level of the pellets to one or more second predetermined thresholds; responsive to continuously comparing the moisture level to the one or more second predetermined thresholds, dynamically adjust the one or more dampers, the first motor load of the blower, or both, thereby adjusting the moisture level of the pellets; determine whether the slurry requires additional or less water based on the second motor load of the centrifugal dryer; and responsive to determining the slurry requires additional or less water, automatically adjust an amount of water to the slurry.

Clause 2: The centrifugal pellet dryer system of clause 1, wherein the one or more spray nozzles are disposed on the one or more lifters of the rotor.

Clause 3: The centrifugal pellet dryer system of any of clauses 1-2, wherein the centrifugal dryer further comprises one or more screens disposed within the housing and surrounding the rotor, and wherein the one or more spray nozzles are disposed on an outer surface of the one or more screens.

Clause 4: The centrifugal pellet dryer system of any of clauses 1-3, wherein the instructions are further configured to cause the one or more processors to: responsive to comparing the moisture level to the one or more second predetermined thresholds, determine whether the moisture level satisfies one or more third predetermined thresholds; responsive to determining the moisture level satisfies a first threshold of the one or more third predetermined thresholds, dynamically adjust the one or more dampers, the first motor load of the blower, or both, to increase the airflow across the centrifugal dryer; and responsive to determining the moisture level satisfies a second threshold of the one or more third predetermined thresholds, dynamically adjust the one or more dampers, the first motor load of the blower, or both, to decrease the airflow across the centrifugal dryer.

Clause 5: The centrifugal pellet dryer system of clause 4, wherein the centrifugal dryer further comprises a second pellet outlet, and wherein the instructions are further configured to cause the one or more processors to: responsive to determining the moisture level satisfies a third threshold of the one or more third predetermined thresholds, automatically divert the pellets out of the second pellet outlet.

Clause 6: The centrifugal pellet dryer system of any of clauses 1-5, wherein the centrifugal dryer further comprises a second pellet outlet, and wherein the instructions are further configured to cause the one or more processors to: responsive to determining the airflow falls below the first predetermined threshold, automatically divert the pellets out of the second pellet outlet before automatically initiating the spray.

Clause 7: The centrifugal pellet dryer system of any of clauses 1-6, wherein the centrifugal dryer further comprises one or more rotor bearing vibration sensors configured to monitor one or more vibration patterns of the rotor, and wherein the instructions are further configured to cause the one or more processors to: continuously monitor the one or more vibration patterns of the rotor via the one or more rotor bearing vibration sensors, wherein determining whether the slurry requires additional or less water is further based on the vibration patterns of the rotor.

Clause 8: The centrifugal pellet dryer system of any of clauses 1-7, wherein automatically adjusting the amount of water to the slurry is conducted by dynamically adjusting a pump speed of a water pump located upstream of the centrifugal dryer.

Clause 9: The centrifugal pellet dryer system of any of clauses 1-8, wherein automatically adjusting the amount of water to the slurry comprises one or more of: adjusting a first amount of water added directly into a slurry feed to the centrifugal dryer, adjusting a pump speed of a water pump located upstream of the centrifugal dryer, adjusting perforation in one or more dryer screens, adjusting a number of blank dryer screens, and adjusting an angle of one or more internal components of the dryer.

Clause 10: The centrifugal pellet dryer system of any of clauses 1-9, wherein the one or more airflow sensors comprise a first airflow sensor and a second airflow sensor, wherein the first airflow sensor is located at the air inlet in ambient conditions, and wherein the second airflow sensor is located at the air outlet.

Clause 11: The centrifugal pellet dryer system of any of clauses 1-10, wherein the one or more processors and the memory are housed within a microcontroller or a programmable logic controller (PLC).

Clause 12: The centrifugal pellet dryer system of any of clauses 1-11, wherein the one or more airflow sensors comprise one or more pressure sensors configured to provide pressure data, and wherein continuously monitoring the airflow across the centrifugal dryer comprises continuously computing the airflow across the centrifugal dryer based on the pressure data.

Clause 13: The centrifugal pellet dryer system of any of clauses 1-12, further comprising a digital display, wherein the instructions are further configured to cause the one or more processors to: continuously display, via the digital display, one or more of the airflow, the moisture level, the first motor load, the second motor load, or combinations thereof.

Clause 14: The centrifugal pellet dryer system of any of clauses 1-14, further comprising: an air filtration device positioned at an outlet of the blower; and an adjustable port positioned between the air outlet of the centrifugal dryer and the blower, wherein the instructions are further configured to cause the one or more processors to: continuously determine a required airflow input rate for the air filtration device; and automatically adjust an airflow input rate into the air filtration device based on the required airflow input rate and the airflow across the centrifugal dryer.

Clause 15: A centrifugal pellet dryer system comprising: a centrifugal dryer comprising: a slurry inlet; a first pellet outlet; an air inlet; and an air outlet; a blower connected to the air outlet of the centrifugal dryer, the blower configured to generate counter-current airflow in relation to a flow of pellets across the centrifugal dryer; one or more dampers positioned at the air outlet; one or more moisture sensors configured to monitor a moisture level of the pellets; one or more processors; and a memory in communication with the one or more processors and storing instructions that, when executed by the one or more processors, are configured to cause the one or more processors to: continuously: monitor (i) the moisture level of the pellets via the one or more moisture sensors, (ii) a first motor load of the blower, and (iii) a second motor load of the centrifugal dryer; compare the moisture level of the pellets to one or more second predetermined thresholds; responsive to comparing the moisture level to the one or more second predetermined thresholds, dynamically adjust the one or more dampers, the first motor load of the blower, or both, thereby adjusting the moisture level of the pellets; determine whether the slurry requires additional or less water based on the second motor load of the centrifugal dryer; and responsive to determining the slurry requires additional or less water, automatically adjust an amount of water to the slurry.

Clause 16: The centrifugal pellet dryer system of clause 15, wherein the instructions are further configured to cause the one or more processors to: continuously determine whether the airflow falls below a first predetermined threshold; and responsive to determining the airflow falls below the first predetermined threshold, automatically conduct one or more functions, wherein the one or more functions comprise one or more of: initiating a self-cleaning function within the centrifugal dryer thereby reducing a build-up of fines within the centrifugal dryer, and generating an alert.

Clause 17: A method of processing plastics through a centrifugal dryer, the method comprising: directing a slurry through the centrifugal dryer, the slurry comprising pellets and water; continuously monitoring (i) an airflow across the centrifugal dryer via one or more airflow sensors, (ii) a moisture level of the pellets in the centrifugal dryer via one or more moisture sensors, and (iii) a first motor load of the centrifugal dryer; continuously determining whether the airflow falls below a first predetermined threshold; responsive to determining the airflow falls below the first predetermined threshold, automatically initiating a self-cleaning function thereby reducing a build-up of fines within the centrifugal dryer; continuously comparing the moisture level of the pellets to one or more second predetermined thresholds; responsive to continuously comparing the moisture level to the one or more second predetermined thresholds, dynamically adjusting one or more components of a blower connected to the centrifugal dryer, thereby adjusting the moisture level of the pellets; continuously determining whether the slurry requires additional or less water based on the first motor load of the centrifugal dryer; and responsive to determining the slurry requires additional or less water, automatically adjusting an amount of water to the slurry.

Clause 18: The method of clause 17, wherein initiating the self-cleaning function comprises initiating a spray via one or more spray nozzles located on one or more lifting assemblies within the centrifugal dryer, the spray comprising water, air, or both.

Clause 19: The method of any of clauses 17-18, wherein the one or more components of the blower comprise one or more dampers, a second motor load of the blower, or both.

Clause 20: The method of any of clauses 17-19, further comprising: continuously monitoring one or more vibration patterns of the centrifugal dryer via one or more vibration sensors, wherein continuously determining whether the slurry requires additional or less water is further based on the one or more vibration patterns of the centrifugal dryer.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

1. A centrifugal pellet dryer system comprising:
a centrifugal dryer comprising:
a slurry inlet;
a first pellet outlet;
an air inlet(s);
an air outlet(s);
a housing; and
a rotor disposed within the housing and comprising one or more lifters and one or more spray nozzles, the rotor configured to convey pellets, via the one or more lifters, upwardly through the centrifugal dryer and discharge the pellets from the first pellet outlet;
a blower connected to the air outlet of the centrifugal dryer, the blower configured to generate counter-current airflow in relation to a flow of the pellets across the centrifugal dryer;
one or more dampers positioned at the air outlet;
one or more moisture sensors configured to monitor a moisture level of the pellets;
one or more airflow sensors configured to monitor an airflow across the centrifugal dryer;
one or more processors; and
a memory in communication with the one or more processors and storing instructions that, when executed by the one or more processors, are configured to cause the one or more processors to:
continuously, until a predetermined amount of dried pellets have been produced:
monitor (i) the airflow across the centrifugal dryer via the one or more airflow sensors, (ii) the moisture level of the pellets via the one or more moisture sensors, (iii) a first motor load of the blower, and (iv) a second motor load of the centrifugal dryer;
determine whether the airflow falls below a first predetermined threshold;
responsive to determining the airflow falls below the first predetermined threshold, automatically initiate a spray via the one or more spray nozzles thereby reducing a build-up of fines within the centrifugal dryer, the spray comprising water, air, or both;
compare the moisture level of the pellets to one or more second predetermined thresholds;
responsive to continuously comparing the moisture level to the one or more second predetermined thresholds, dynamically adjust the one or more dampers, the first motor load of the blower, or both, thereby adjusting the moisture level of the pellets;
determine whether the slurry requires additional or less water based on the second motor load of the centrifugal dryer; and
responsive to determining the slurry requires additional or less water, automatically adjust an amount of water to the slurry.

2. The centrifugal pellet dryer system of claim 1, wherein the one or more spray nozzles are disposed on the one or more lifters of the rotor.

3. The centrifugal pellet dryer system of claim 1, wherein the centrifugal dryer further comprises one or more screens disposed within the housing and surrounding the rotor, and wherein the one or more spray nozzles are disposed on an outer surface of the one or more screens.

4. The centrifugal pellet dryer system of claim 1, wherein the instructions are further configured to cause the one or more processors to:
responsive to comparing the moisture level to the one or more second predetermined thresholds, determine whether the moisture level satisfies one or more third predetermined thresholds;
responsive to determining the moisture level satisfies a first threshold of the one or more third predetermined thresholds, dynamically adjust the one or more dampers, the first motor load of the blower, or both, to increase the airflow across the centrifugal dryer; and
responsive to determining the moisture level satisfies a second threshold of the one or more third predetermined thresholds, dynamically adjust the one or more dampers, the first motor load of the blower, or both, to decrease the airflow across the centrifugal dryer.

5. The centrifugal pellet dryer system of claim 4, wherein the centrifugal dryer further comprises a second pellet outlet, and wherein the instructions are further configured to cause the one or more processors to:
responsive to determining the moisture level satisfies a third threshold of the one or more third predetermined thresholds, automatically divert the pellets out of the second pellet outlet.

6. The centrifugal pellet dryer system of claim 1, wherein the centrifugal dryer further comprises a second pellet outlet, and wherein the instructions are further configured to cause the one or more processors to:
responsive to determining the airflow falls below the first predetermined threshold, automatically divert the pellets out of the second pellet outlet before automatically initiating the spray.

7. The centrifugal pellet dryer system of claim 1, wherein the centrifugal dryer further comprises one or more rotor bearing vibration sensors configured to monitor one or more vibration patterns of the rotor, and wherein the instructions are further configured to cause the one or more processors to:
continuously monitor the one or more vibration patterns of the rotor via the one or more rotor bearing vibration sensors,
wherein determining whether the slurry requires additional or less water is further based on the vibration patterns of the rotor.

8. The centrifugal pellet dryer system of claim 1, wherein automatically adjusting the amount of water to the slurry is conducted by dynamically adjusting a pump speed of a water pump located upstream of the centrifugal dryer.

9. The centrifugal pellet dryer system of claim 1, wherein automatically adjusting the amount of water to the slurry comprises one or more of:
adjusting a first amount of water added directly into a slurry feed to the centrifugal dryer,
adjusting a pump speed of a water pump located upstream of the centrifugal dryer,
adjusting perforation in one or more dryer screens,
adjusting a number of blank dryer screens, and
adjusting an angle of one or more internal components of the dryer.

10. The centrifugal pellet dryer system of claim 1, wherein the one or more airflow sensors comprise a first airflow sensor and a second airflow sensor, wherein the first airflow sensor is located at the air inlet in ambient conditions, and wherein the second airflow sensor is located at the air outlet.

11. The centrifugal pellet dryer system of claim 1, wherein the one or more processors and the memory are housed within a microcontroller or a programmable logic controller (PLC).

12. The centrifugal pellet dryer system of claim 1, wherein the one or more airflow sensors comprise one or more pressure sensors configured to provide pressure data, and wherein continuously monitoring the airflow across the centrifugal dryer comprises continuously computing the airflow across the centrifugal dryer based on the pressure data.

13. The centrifugal pellet dryer system of claim 1, further comprising a digital display, wherein the instructions are further configured to cause the one or more processors to:
continuously display, via the digital display, one or more of the airflow, the moisture level, the first motor load, the second motor load, or combinations thereof.

14. The centrifugal pellet dryer system of claim 1, further comprising:
an air filtration device positioned at an outlet of the blower; and
an adjustable port positioned between the air outlet of the centrifugal dryer and the blower,
wherein the instructions are further configured to cause the one or more processors to:
continuously determine a required airflow input rate for the air filtration device; and
automatically adjust an airflow input rate into the air filtration device based on the required airflow input rate and the airflow across the centrifugal dryer.

15. A centrifugal pellet dryer system comprising:
a centrifugal dryer comprising:
a slurry inlet;
a first pellet outlet;
an air inlet; and
an air outlet;
a blower connected to the air outlet of the centrifugal dryer, the blower configured to generate counter-current airflow in relation to a flow of pellets across the centrifugal dryer;
one or more dampers positioned at the air outlet;
one or more moisture sensors configured to monitor a moisture level of the pellets;
one or more processors; and
a memory in communication with the one or more processors and storing instructions that, when executed by the one or more processors, are configured to cause the one or more processors to:
continuously:
monitor (i) the moisture level of the pellets via the one or more moisture sensors, (ii) a first motor load of the blower, and (iii) a second motor load of the centrifugal dryer;
compare the moisture level of the pellets to one or more second predetermined thresholds;
responsive to comparing the moisture level to the one or more second predetermined thresholds, dynamically adjust the one or more dampers, the first motor load of the blower, or both, thereby adjusting the moisture level of the pellets;
determine whether the slurry requires additional or less water based on the second motor load of the centrifugal dryer; and
responsive to determining the slurry requires additional or less water, automatically adjust an amount of water to the slurry.

16. The centrifugal pellet dryer system of claim 15, wherein the instructions are further configured to cause the one or more processors to:
continuously determine whether the airflow falls below a first predetermined threshold; and
responsive to determining the airflow falls below the first predetermined threshold, automatically conduct one or more functions, wherein the one or more functions comprise one or more of:
initiating a self-cleaning function within the centrifugal dryer thereby reducing a build-up of fines within the centrifugal dryer, and
generating an alert.

17. A method of processing plastics through a centrifugal dryer, the method comprising:
directing a slurry through the centrifugal dryer, the slurry comprising pellets and water;
continuously monitoring (i) an airflow across the centrifugal dryer via one or more airflow sensors, (ii) a moisture level of the pellets in the centrifugal dryer via one or more moisture sensors, and (iii) a first motor load of the centrifugal dryer;
continuously determining whether the airflow falls below a first predetermined threshold;
responsive to determining the airflow falls below the first predetermined threshold, automatically initiating a self-cleaning function thereby reducing a build-up of fines within the centrifugal dryer;
continuously comparing the moisture level of the pellets to one or more second predetermined thresholds;
responsive to continuously comparing the moisture level to the one or more second predetermined thresholds, dynamically adjusting one or more components of a blower connected to the centrifugal dryer, thereby adjusting the moisture level of the pellets;
continuously determining whether the slurry requires additional or less water based on the first motor load of the centrifugal dryer; and
responsive to determining the slurry requires additional or less water, automatically adjusting an amount of water to the slurry.

18. The method of claim 17, wherein initiating the self-cleaning function comprises initiating a spray via one or more spray nozzles located on one or more lifting assemblies within the centrifugal dryer, the spray comprising water, air, or both.

19. The method of claim 17, wherein the one or more components of the blower comprise one or more dampers, a second motor load of the blower, or both.

20. The method of claim 17, further comprising:
continuously monitoring one or more vibration patterns of the centrifugal dryer via one or more vibration sensors,
wherein continuously determining whether the slurry requires additional or less water is further based on the one or more vibration patterns of the centrifugal dryer.
